(19) United States
(12) Patent Application Publication
(10) Pub. No.: US 2025/0379671 A1
(43) Pub. Date: Dec. 11, 2025

(54) SYSTEMS AND METHODS FOR MEASURING SIGNAL TO NOISE RATIO (SNR) FOR UPLINK RECEIVER CHAIN

(71) Applicant: JIO PLATFORMS LIMITED, Ahmedabad (IN)

(72) Inventors: Yashesh BUCH, Navi Mumbai (IN); Vinita KAUSHIK, Navi Mumbai (IN); Santhiswaroop CHINNAM, Andhra Pradesh (IN); Gayathri R. NAIR, Kerala (IN)

(73) Assignee: JIO PLATFORMS LIMITED, Ahmedabad (IN)

(21) Appl. No.: 18/878,013

(22) PCT Filed: Jul. 20, 2023
(86) PCT No.: PCT/IB2023/057405

§ 371 Date: Dec. 21, 2024

(30) Foreign Application Priority Data
Jul. 21, 2022 (IN) 202221041708

(51) Int. Cl. H04B 17/309; H04B 17/318

(52) U.S. Cl. CPC H04B 17/346; H04B 17/328

(57) ABSTRACT

The present disclosure relates to a system and a method for measuring Signal to Noise Ratio (SNR) for an uplink receiver chain. The system receives at least one Demodulation Reference Signal (DMRS) symbol from at least one signal of a plurality of signals transmitted by a plurality of User Equipments (UEs) in the uplink receiver chain, determines Received Signal Strength Indicator (RSSI) of the at least one signal of each UE based on the at least one DMRS symbol, determine an average Noise Variance (NV) of the at least one signal of each UE in response to a determination of the RSSI of the at least one signal of each UE, and measure SNR for the at least one signal of each UE in the uplink receiver chain based on the RSSI of the at least one signal and the average NV of the at least one signal.

RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to wireless communication systems. In particular, the present disclosure relates to a system and a method for measuring a Signal to Noise (SNR) ratio for an uplink receiver chain.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Generally, a Signal to Noise Ratio (SNR) may be a measure of signal power to noise power. Higher the SNR ratio, signal quality is better and less noise in a Radio Frequency (RF) environment. Further, lower the SNR ratio, a received signal quality is poor resulting in Block Error Rate (BLER) and loss of throughput. For a given SNR, there may be a higher probability of error as a modulation order increases (i.e., from Binary Phase Shift Keying (BPSK) to 256 Quadrature Amplitude Modulation (QAM)). Similarly, for the given modulation order, there may be a higher probability of error as the SNR reduces.

Additionally, based on a correlation of a Channel Quality Indicator (CQI) reported by a User Equipment (UE) and the SNR measured and reported by an uplink receiver chain at a g-Node B (gNB), the gNB changes a code rate in higher layers by reducing a Modulation and Coding Scheme (MCS), as the CQI value reduces or vice versa. Hence, the SNR may be a very important metric indicative of throughput rates.

There is therefore a need in the art to provide systems and methods for measuring a Signal to Noise (SNR) ratio for an uplink receiver chain that can overcome the shortcomings of the existing prior arts.

### OBJECTS OF THE PRESENT DISCLOSURE

Some of the objects of the present disclosure, which at least one embodiment herein satisfies are as listed herein below.

It is an object of the present disclosure to provide systems and methods for measuring a Signal to Noise (SNR) ratio for an uplink receiver chain.

It is an object of the present disclosure to achieve accurate SNR reporting to higher layers of a core network for better receiver performance.

It is an object of the present disclosure to enable optimal implementation of SNR unit using fewer Field Programmable Gate Array (FPGA) resources.

It is an object of the present disclosure to use different methods implemented in the FPGA to achieve good performance of reporting in negative ranges of SNR.

It is an object of the present disclosure to determine Received Signal Strength Indicator (RSSI) values and Noise Variance (NV) values in FPGA for determining the SNR.

It is an object of the present disclosure to allow user-by-user measurement of SNR values, thereby saving FPGA resources by serializing the measurements.

It is an object of the present disclosure to provide systems and methods for adding an offset to the calculated SNR values, which may tune the reporting as per a noise figure of radio and quantization noise at an Analog to Digital Converter (ADC).

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for measuring Signal to Noise Ratio (SNR) for an uplink receiver chain. The system includes one or more processors, and a memory operatively coupled to the one or more processors. The memory includes processor-executable instructions, which on execution, cause the one or more processors to receive at least one Demodulation Reference Signal (DMRS) symbol from at least one signal of a plurality of signals transmitted by a plurality of User Equipments (UEs) in the uplink receiver chain, determine Received Signal Strength Indicator (RSSI) of the at least one signal of each UE of the plurality of UEs based on the at least one DMRS symbol; determine an average Noise Variance (NV) of the at least one signal of each UE in response to the determination of the RSSI of the at least one signal of each UE, and measure the SNR for the at least one signal of each UE in the uplink receiver chain based on the RSSI of the at least one signal and the average NV of the at least one signal.

In an embodiment, the RSSI of the at least one signal may be an average signal strength of the at least one signal.

In an embodiment, the one or more processors may determine the average NV of the at least one signal of each UE by being configured to estimate one or more smoothened channels of the at least one signal and one or more frequency interpolated channels of the at least one signal based on the at least one DMRS symbol, determine noise mean power per antenna per Resource Element (RE) from the estimated one or more smoothened channels and the estimated one or more frequency interpolated channels, and determine the average NV of the at least one signal of each UE based on the noise mean power per antenna per RE.

In an embodiment, the one or more processors may measure the SNR for the at least one signal of each UE by being configured to determine power of the at least one signal of each UE based on the RSSI of the at least one signal, and measure the SNR for the at least one signal of each UE in the uplink receiver chain based on the power of the at least one signal of each UE and the noise mean power per antenna per RE.

In an embodiment, the one or more processors may determine the power of the at least one signal of each UE by being configured to estimate a User Identity (UID) flag value and a concatenated RSSI value from the RSSI of the at least one signal to set an internal RSSI flag, estimate concatenated NV value from the average NV of the at least one signal to set an internal NV flag, set an internal enable signal based on the internal RSSI flag and the internal NV flag, process the UID flag value, the concatenated RSSI value, and the concatenated NV value based on the internal enable signal, and determine the power of the at least one signal of each UE based on the processed values.

In an embodiment, the memory includes processor-executable instructions, which on execution, may cause the one or more processors to send, via a Functional Application Platform Interface (FAPI), a SNR measurement report of each UE in the uplink receiver chain to one or more higher layers of a base station.

In an embodiment, the memory includes processor-executable instructions, which on execution, may cause the one or more processors to add an offset to the measured SNR, which tunes a SNR measurement report of each UE as per a noise figure of radio and quantization noise at an Analog to Digital Converter (ADC).

In another aspect, the present disclosure relates to a method for measuring SNR for an uplink receiver chain. The method includes receiving, by a processor associated with a system, at least one DMRS symbol from at least one signal of a plurality of signals transmitted by a plurality of UEs in the uplink receiver chain, determining, by the processor, RSSI of the at least one signal of each UE of the plurality of UEs based on the at least one DMRS symbol, determining, by the processor, an average Noise Variance (NV) of the at least one signal of each UE in response to the determination of the RSSI of the at least one signal of each UE, and measuring, by the processor, the SNR for the at least one signal of each UE in the uplink receiver chain based on the RSSI of the at least one signal and the average NV of the at least one signal.

In an embodiment, the RSSI of the at least one signal may be an average signal strength of the at least one signal.

In an embodiment, determining, by the processor, the average NV of the at least one signal of each UE may include estimating, by the processor, one or more smoothened channels of the at least one signal and one or more frequency interpolated channels of the at least one signal based on the at least one DMRS symbol, determining, by the processor, noise mean power per antenna per Resource Element (RE) from the estimated one or more smoothened channels and the estimated one or more frequency interpolated channels, and determining, by the processor, the average NV of the at least one signal of each UE based on the noise mean power per antenna per RE.

In an embodiment, measuring, by the processor, the SNR for the at least one signal of each UE may include determining, by the processor, power of the at least one signal of each UE based on the RSSI of the at least one signal, and measuring, by the processor, the SNR for the at least one signal of each UE in the uplink receiver chain based on the power of the at least one signal of each UE and the noise mean power per antenna per RE.

In an embodiment, determining, by the processor, the power of the at least one signal of each UE may include estimating, by the processor, a User Identity (UID) flag value and a concatenated RSSI value from the RSSI of the at least one signal to set an internal RSSI flag, estimating, by the processor, a concatenated NV value from the average NV of the at least one signal to set an internal NV flag, setting, by the processor, an internal enable signal based on the internal RSSI flag and the internal NV flag, processing, by the processor, the UID flag value, the concatenated RSSI value and the concatenated NV value based on the internal enable signal, and determining, by the processor, the power of the at least one signal of each UE based on the processed values.

In an embodiment, the method may include sending, via a FAPI, by the processor, a SNR measurement report of each UE in the uplink receiver chain to one or more higher layers of a base station.

In an embodiment, the method may include adding, by the processor, an offset to the measured SNR, which tunes a SNR measurement report of each UE as per a noise figure of radio and quantization noise at an Analog to Digital Converter (ADC).

In another aspect, the present disclosure relates to a user equipment. The user equipment includes one or more processors, and a memory operatively coupled to the one or more processors, wherein the memory includes processor-executable instructions, which on execution, cause the one or more processors to transmit, via a wireless network, a plurality of signals to a system. The one or more processors are communicatively coupled with the system, and the system is configured to receive at least one DMRS symbol from at least one signal of the plurality of signals, determine RSSI of the at least one signal of the UE based on the at least one DMRS symbol, determine an average NV of the at least one signal of the UE in response to a determination of the RSSI of the at least one signal of the UE, and measure SNR for the at least one signal of the UE in the uplink receiver chain based on the RSSI of the at least one signal and the average NV of the at least one signal.

In an aspect, the present disclosure relates to a non-transitory computer-readable medium including processor-executable instructions that cause a processor to receive at least one DMRS symbol from at least one signal of the plurality of signals transmitted by a plurality of User Equipments (UEs) (104) in an uplink receiver chain. determine RSSI of the at least one signal of each UE of a plurality of UEs based on the at least one DMRS symbol, determine an average NV of the at least one signal of each UE in response to the determination of the RSSI of the at least one signal of each UE, and measure SNR for the at least one signal of each UE in the uplink receiver chain based on the RSSI of the at least one signal and the average NV of the at least one signal.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

The diagrams are for illustration only, which thus is not a limitation of the present disclosure, and wherein:

FIG. 1 illustrates an exemplary network architecture (100) in which or with which the proposed system of the present disclosure may be implemented.

FIG. 2A illustrates an exemplary block diagram (200A) of a system for measuring a Signal to Noise (SNR) ratio for an uplink receiver chain, in accordance with an embodiment of the present disclosure.

FIG. 2B illustrates an exemplary block diagram (200B) of functional elements of a base station, in accordance with an embodiment of the present disclosure.

FIG. 3A illustrates an exemplary block diagram (300A) of a Symbol Rate Processing (SRP) unit, in accordance with an embodiment of the present disclosure.

FIG. 3B illustrates an exemplary block diagram (300B) of a SNR measurement unit implemented in a Field Programmable Gate Array (FPGA), in accordance with an embodiment of the present disclosure.

FIG. 4 illustrates an exemplary block diagram of a computer system (400) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process. many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In general, Signal to Noise Ratio (SNR) may be a ratio of signal power to a noise power, expressed in decibels (dB). Higher SNR ratio means that there is better signal quality and lesser noise in a Radio Frequency (RF) environment. If the SNR ratio is lower, that means that the received signal quality is poor resulting in Block Error Rate (BLER) and loss of throughput. For a given SNR, there may be a higher probability of error as a modulation order increases (i.e., from Binary Phase-shift keying (BPSK) to 256 Quadrature Amplitude Modulation (QAM)). Similarly, for the given modulation order, there may be a higher probability of error as the SNR reduces. Additionally, based on a correlation of a Channel Quality Indicator (CQI) reported by a User Equipment (UE) and the SNR measured and reported by an uplink receiver chain at a g-Node B (gNB), the gNB changes a code rate in higher layers by reducing a Modulation and Coding Scheme (MCS), as the CQI value reduces or vice versa. Hence, the SNR may be a very important metric indicative of throughput rates. Therefore, there is a need for measuring the SNR value accurately for reporting to higher layers of the gNB.

The present disclosure provides a system and a method for measuring SNR ratio for the uplink receiver chain. The present disclosure performs SNR measurement for each UE in the uplink receiver chain and passes the SNR measurement to Protocol Stack (PS)/higher layers for SNR reporting to a core network via a Functional Application Platform Interface (FAPI).

Furthermore, the present disclosure achieves accurate SNR reporting to higher layers of a core network for better receiver performance. The present disclosure enables optimal implementation of a SNR unit using fewer Field Programmable Gate Array (FPGA) resources. The present disclosure uses different methods implemented in the FPGA to achieve good performance of reporting in negative ranges of SNR. The present disclosure provides systems and methods for calculating Received Signal Strength Indicator (RSSI) values and Noise Variance (NV) values in FPGA for determining the SNR. The present disclosure allows user-by-user calculation of SNR values, thereby saving FPGA resources by serializing the calculations. The present disclosure provides systems and methods for adding an offset to the calculated SNR values, which tunes the reporting as per the noise figure of the radio and quantization noise at an Analog to Digital Converter (ADC).

Certain terms and phrases have been used throughout the disclosure and will have the following meanings in the context of the ongoing disclosure.

The term “SNR” may refer to a Signal to Noise ratio which is a measure of the signal power to the noise power, often expressed in decibels (dB).

The term “RSSI” may refer to a received signal strength indicator or a received signal strength indication which is a measurement of the power present in a received radio signal.

The term “NV” may refer to an average noise variance calculated from smoothened channel estimates and frequency interpolated channel estimates.

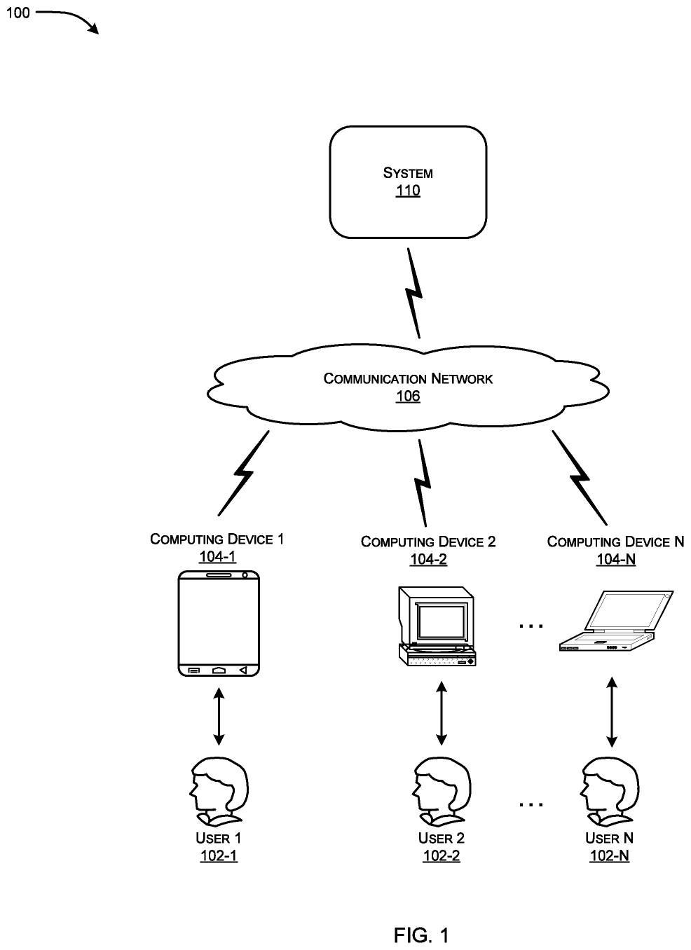

Various embodiments of the present disclosure will be explained in detail with reference to FIGS. 1-4.

FIG. 1 illustrates an exemplary network architecture (100) for a Signal to Noise (SNR) ratio measuring system (also referred to as a network architecture (100)) in which or with which a system (110) of the present disclosure may be implemented. With respect to FIG. 1, the network architecture (100) may be equipped with the system (110) for measuring a SNR ratio for each of one or more first computing devices (104-1, 104-2 . . . 104-N) (individually referred to as a first computing device (104) and collectively referred to as the first computing devices (104)) associated with one or more users (102-1, 102-2 . . . 102-N) (individually referred to as the user (102) and collectively referred to as the users (102)). The first computing devices (104) may be connected to a core network (not shown in FIG. 1). The core network may include, but is not limited to, a Third Generation (3G), a Fourth Generation (4G), a Fifth Generation (5G), a Sixth Generation (6G), a New Radio (NR), a Narrow Band Internet of Things (NB-IOT), an open Radio Access Network (o-RAN), and the like.

In an embodiment, the one or more first computing devices (104-1, 104-2 . . . 104-N) may also be referred as one or more User Equipments (UEs) (104-1, 104-2 . . . 104-N). The user equipment (104) may include smart devices operating in a smart environment, for example, an Internet of Things (IOT) system. In such an embodiment, the user equipment (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users (102), or any combination thereof.

A person of ordinary skill in the art will appreciate that the user equipment (104) may include, but is not limited to, intelligent, multi-sensing, network-connected devices, that can integrate seamlessly with each other and/or with a central server or a cloud-computing system or any other device that is network-connected.

In an embodiment, the user equipment (104) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user (102) or the entity such as touch pad, touch enabled screen, electronic pen, and the like.

A person of ordinary skill in the art will appreciate that the user equipment (104) may not be restricted to the mentioned devices and various other devices may be used.

Referring to FIG. 1, the user equipment (104) may communicate with the system (110), for example, the SNR ratio measuring system, through a communication network (106). In an embodiment, the communication network (106) may include a 5G network, or the like. The network (106) may enable the user equipment (104) to communicate with other devices in the network architecture (100) and/or with the system (110). The communication network (106) may include a wireless card or some other transceiver connection to facilitate this communication. In another embodiment, the communication network (106) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like.

In an exemplary embodiment, the communication network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The communication network (106) may include, by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber-optic network, some combination thereof.

In an embodiment, the system (110) may be communicatively connected to the core network (not shown in FIG. 1) such as the 3G, 4G, 5G, 6G, NR, NB-IoT, o-RAN, and the like, for measuring the SNR ratio for the uplink receiver chain. The system (110) may calculate RSSI values and NV values using a FPGA unit. The system (110) may be connected to the FPGA unit.

In an embodiment, the system (110) may calculate SNR values for each of the UE (104), thereby saving FPGA resources by serializing the calculations.

In an embodiment, the system (110) may report SNR values to higher layers for better receiver performance, and achieve good performance in reporting SNR values in a negative range by implementing different methods of SNR calculation.

In an embodiment, the system (110) may add an offset to the calculated SNR values, to tune the reporting as per the noise figure of the radio and quantization noise at an Analog to Digital Converter (ADC).

In an embodiment, the system (110) may be a System on Chip (SoC) system but not limited to the like. In another embodiment, an onsite data capture, storage, matching, processing, decision-making, and actuation logic may be coded using Micro-Services Architecture (MSA) but not limited to it. A plurality of microservices may be containerized and may be event-based to support portability.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

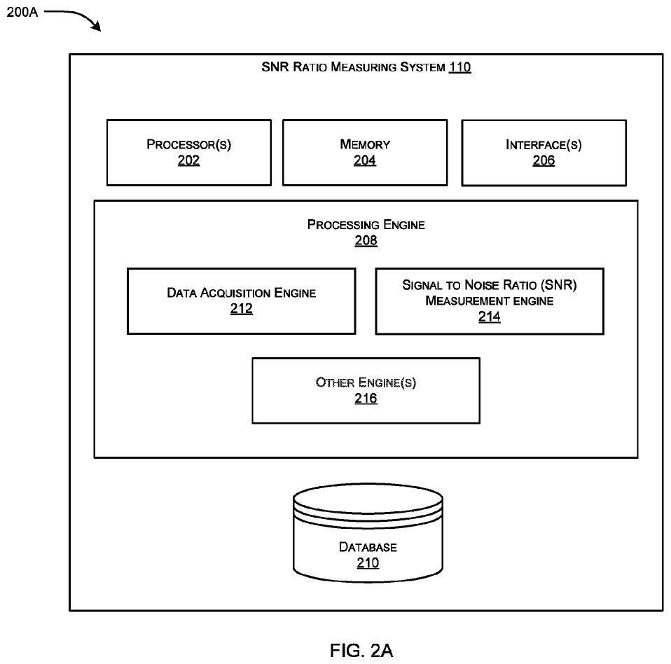

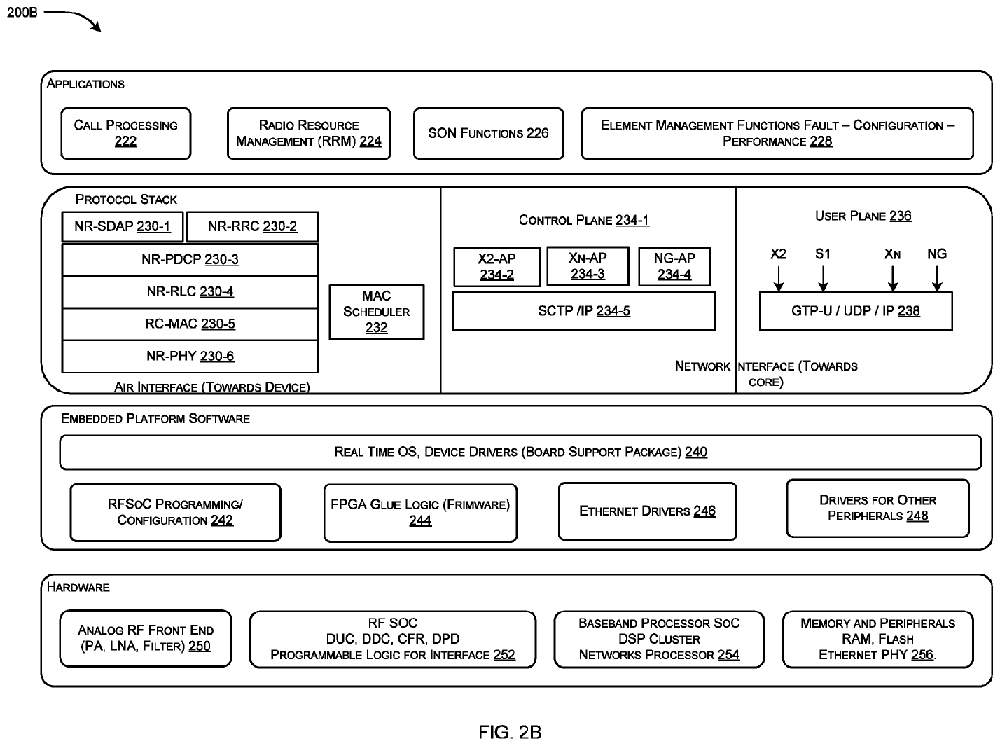

FIG. 2A illustrates an exemplary block diagram (200A) of the system (110) for measuring a SNR ratio for an uplink receiver chain, in accordance with an embodiment of the present disclosure.

In an aspect, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, one or more processor(s) (202) may be configured to fetch and execute computer-readable instructions stored in a memory (204) of the system (110). The memory (204) may be configured to store one or more computer-readable instructions or routines in a non-transitory computer-readable storage medium, which may be fetched and executed to create or share data packets over a network service. The memory (204) may comprise any non-transitory storage device including, for example, volatile memory such as Random-Access Memory (RAM), or non-volatile memory such as Erasable Programmable Read-Only Memory (EPROM), flash memory, and the like.

In an embodiment, the system (110) may include an interface(s) (206). The interface(s) (206) may include a variety of interfaces, for example, interfaces for data input and output devices, referred to as I/O devices, storage devices, and the like. The interface(s) (206) may facilitate communication of the system (110). The interface(s) (206) may also provide a communication pathway for one or more components of the system (110). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by an electronic circuitry.

The processing engine (208) may include one or more engines selected from any of a data acquisition engine (212), a SNR measurement engine (214), and other engines/units (216).

In an embodiment, the data acquisition engine (212) may receive Demodulation Reference Signal (DMRS) symbol from at least one signal of a plurality of signals transmitted by the UEs (104) in the uplink receiver chain.

In an embodiment, the SNR measurement engine (214) may determine RSSI of the at least one signal of each UE of the plurality of UEs (104) based on the at least one DMRS symbol. The SNR measurement engine (214) may determine an average NV of the at least one signal of each UE (104) in response to the determination of the RSSI of the at least one signal of each UE (104) and measure SNR values for each UE of the UEs (104), thereby saving FPGA resources by serializing the measurements. In an embodiment, the SNR measurement engine (214) may report SNR values to higher layers for better receiver performance, and achieve good performance in reporting SNR values in the negative range by implementing different methods of SNR measurement. In an embodiment, the SNR measurement engine (214) may add an offset to the measured SNR values, to tune the reporting as per the noise figure of the radio and quantization noise at the ADC.

In an embodiment, the database (210) may comprise data that may be either stored or generated as a result of functionalities implemented by any of the components of the processor(s) (202) or the processing engine(s) (208) or the system (110).

Although FIG. 2A shows an exemplary block diagram (200) of the SNR ratio measuring system (110), in other embodiments, the SNR ratio measuring system (110) may include fewer components, different components, differently arranged components, or additional functional components than depicted in FIG. 2A. Additionally, or alternatively, one or more components of the SNR ratio measuring system (110) may perform functions described as being performed by one or more other components of the SNR ratio measuring system (110).

FIG. 2B illustrates an exemplary block diagram (200B) of functional elements of a base station, in accordance with an embodiment of the present disclosure.

With respect to FIG. 2B, the base station may be, for example, a high-level, gNodeB (gNB). The high-level, gNB (small cell) may be composed of plurality of ‘layers’ such as a hardware layer, an embedded platform software layer, a 5G protocol stack, and application layers. The hardware layer may include a Radio Frequency (RF) front end (such as Power Amplifier (PA), Low Noise Amplifier (LNA), filters, and the like) and antennas (250), a RF System on Chip (SoC) (252) (such as a Digital Up Converter (DUC), a Digital Down Converter (DDC), a Digital Pre Distortion (DPD), a Crest Factor Reduction (CFR), a programmable logic for an interface, and the like), a baseband processor SoC (254) (such as a Digital Signal Processing (DSP) cluster, network, a network processor, and the like), a memory and peripheral (256) (such as a Random Access Memory (RAM), a Flash memory, an Ethernet physical layer memory, and the like).

In an embodiment, the embedded software platform layer may include a Real-Time Operating System (RTOS), device drivers for various peripherals including a Peripheral Component Interconnect express (PCIe), an Ethernet, memories, Radio Frequency System on Chip (RFSoC) programming/configuration, FPGA, and the like.

In an embodiment, the 5G protocol stack may include a New Radio Physical Layer (NR-PHY) (230-6), a NR Medium Access Control (NR-MAC) (230-5), a MAC scheduler (232), a NR Radio Link Control (NR-RLC) (230-4), a NR Packet Data Convergence Protocol (NR-PDCP) (230-3), a NR Radio Resource Control (NR-RRC) (230-2), and a NR Service Data Adaption Protocol (NR-SDAP) (230-1).

The layered view of the small cell may include a Layer-1 (Physical Layer (PHY)), which may be hosted on the FPGA. The PHY may include two major components processor cores (termed as processing system) and a FPGA fabric (programmable Logic). The Processing System (PS) may include processor cores, which may host a Functional Application Platform Interface (FAPI) layer, Layer 1 controller and some components or physical layer processing. The Programmable Logic (PL)/FPGA based compute fabric may host a Downlink and Uplink Signal Processing chains of the PHY. The PS may include system logic cells, Configurable Logic Blocks (CLBs) flip-flops, CLB Look Up Tables (LUTs), Digital Signal Processor (DSP) slices, Block Random Access Memory (RAM) and Ultra RAM in form of memory. Some integrated RFSoCs may also have Analog to Digital Converter (ADCs), and Digital to Analog Converter (DACs) inbuilt in a PL space. The RFSoc may also include the PCIe, Serial Advanced Technology Attachment (SATA), Serial Gigabit Media-Independent Interface (SGMII), Universal Asynchronous Receiver-Transmitter (UART), Universal Serial Bus (USB), Inter-Integrated Circuit (I2C), Serial Peripheral Interface (SPI), General Purpose Input/Output (GPIO), 10 Gigabit (10G) Ethernet ports for connectivity options. Further, in a control plane (234-1), the interface may include an X2-Application Protocol (X2AP) (234-2), an Xn-AP (234-3), a NG-AP (234-4), a Stream Control Transmission Protocol/Internet Protocol (SCTP/IP) (234-5), and the like. Further, in a user plane (236), the interfaces may include an X2, a S1, an Xn, a NG, a GPRS Tunnelling Protocol User Plane (GTP-U)/User Datagram Protocol (UDP)/Internet Protocol (IP) (238), and the like.

In an embodiment, the application layer may include a Radio Resource Management (RRM) module (224), which include functions such as call processing function (222), Self-Organizing Networks (SON) functions (226), and Operations and Maintenance (O&M) functions (228) (such as element management functions fault-configuration-performance), and the like.

Although FIG. 2B shows the functional elements of the base station, in other embodiments, the gNB may include fewer components, different components, differently arranged components, or additional functional components than depicted in FIG. 2B. Additionally, or alternatively, one or more components of the gNB may perform functions described as being performed by one or more other components of the gNB.

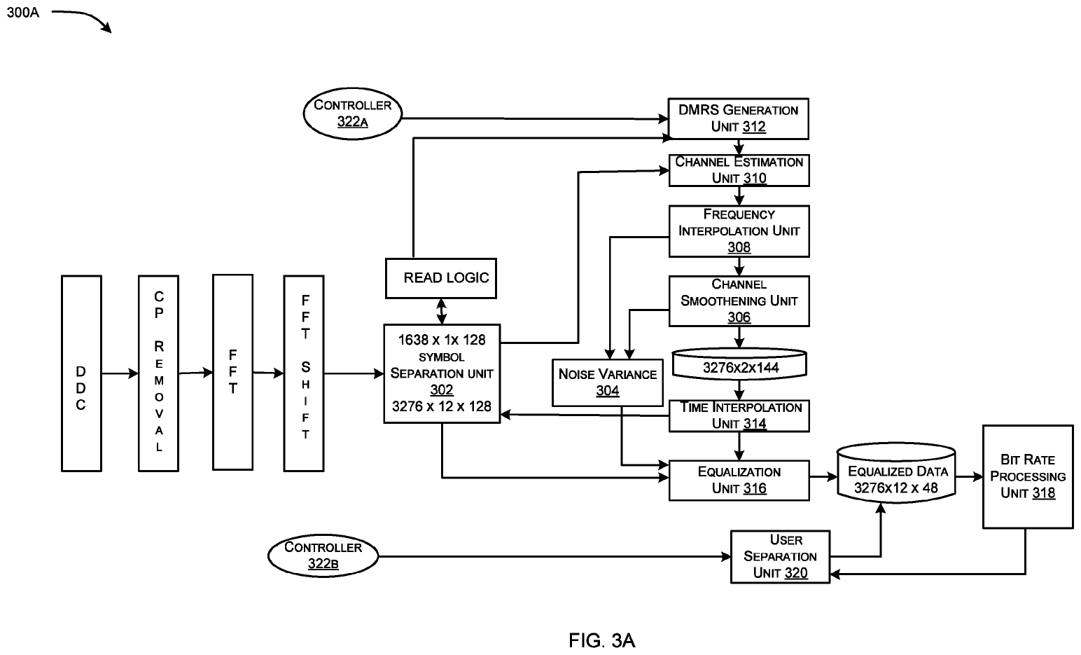

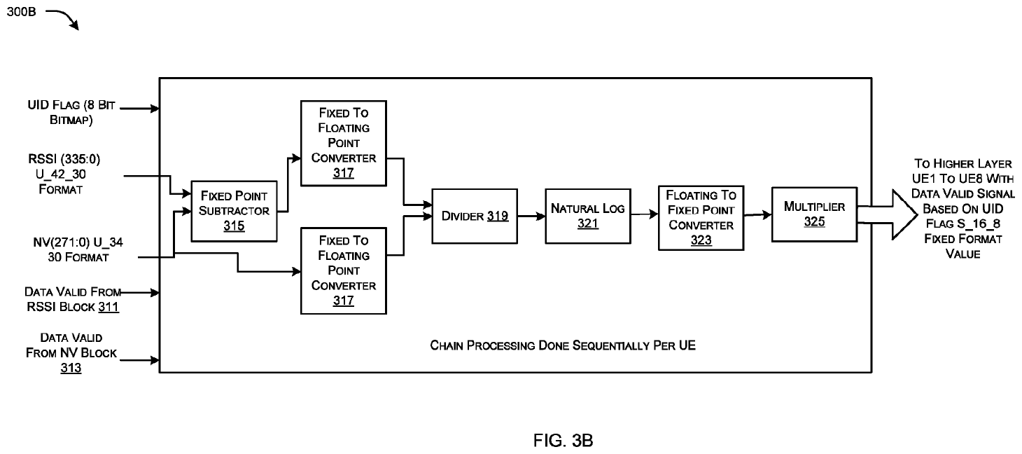

FIG. 3A illustrates an exemplary block diagram (300A) of Symbol Rate Processing (SRP) unit, in accordance with an embodiment of the present disclosure.

With respect to FIG. 3A, SRP units may include a symbol separation unit (302). The symbol separation unit (302) may separate data and Demodulation Reference Signal (DMRS) symbols of the signals. The data may be processed using different techniques such as Digital Down Conversion (DDC), Cyclic Prefix (CP) removal, Fast Fourier Transform (FFT), and FFT shift. The SNR may be measured over one or all the DMRS symbols. The SRP unit may consider that the SNR measurement occurs after the reception of the first DMRS symbol. The SRP unit includes other units such as a DMRS generation unit (312), a time interpolation unit (314), an equalization unit (316), a user separation unit (320). a bit rate processing unit (318), controllers (322A, 322B), and the like to perform SNR measurement.

The SNR measurement may be performed in the following approaches:
a. Approach 1: The system (110) may measure the SNR for the signal received from a RSSI measurement unit (not shown in FIG. 3A) and a Noise Variance (NV) value received from a NV unit (304), which is determined using below equation 1:

$$SNR ( dB ) = 10 log 10 ( ( RSSI - NV ) / NV ) \qquad Equation 1$$

In the above equation 1, the RSSI may be an average received signal strength determined from the output of the symbol separation unit (302). The NV may be an average noise variance determined from a smoothened channel estimate received from a channel smoothing unit (306) and a frequency interpolated channel estimate received from a frequency interpolation unit (308).

b. Approach 2: The system (110) may measure the SNR for the signal received from the RSSI measurement unit and the NV values received from the NV unit (304), which is determined using equation 2:

$$SNR ( dB ) = 10 log 10 ( H 2 / σ2 ) \qquad Equation 2$$

In the above equation, ‘H2’ may be the mean of the square of the estimated channel (output of channel estimation unit (310)) over all antennas and REs. Further, ‘σ2’ may be the Noise Mean Power per antenna per RE calculated from Smoothened Channel estimates and frequency interpolated channel estimates.
c. Approach 3: Approach 3 may be an enhancement to approach 2, where a curve fitting may be applied to an output of approach 2 to realize better reporting performance in negative SNR ranges. The curve fitting may be determined as polynomial as shown in equation 3:

$$Y = {Ax}^{2} + Bx + C \qquad Equation 3$$

d. Approach 4: The system (110) may measure the SNR for the signal received from an output of the channel smoothening unit (306) and the noise calculated as Y-H.X, where ‘Y’ may be the received signal, ‘H’ may be the output for channel smoothening unit (306) and ‘X’ may be DMRS generated signal received from the DNMRS generation unit (312), which is calculated using below equation 4:

$$SNR ( dB ) = 10 log 10 ( H 2 / σ2 ) \qquad Equation 4$$

Although FIG. 3A shows the exemplary block diagram (300A) of the SRP unit, in other embodiments, the SRP unit may include fewer components, different components, differently arranged components, or additional functional components than depicted in FIG. 3A. Additionally, or alternatively, one or more components of the SRP unit may perform functions described as being performed by one or more other components of the SRP unit.

FIG. 3B illustrates an exemplary block diagram (300B) representation of a SNR measurement unit implemented in a FPGA, in accordance with an embodiment of the present disclosure. The SNR measurement unit (300B) may measure the SNR for the signal coming from the RSSI measurement unit and the NV from the NV block. The measured SNR value may be sent to a PS which reports to higher layers as per FAPI compliance shown below:

| | | |
|---|---|---|
| UL_CQI | Uint8_t | SNR |
| | | Value: 0-255, representing −64 dB to |
| | | 63 dB, with 0.5 dB step size. |
| | | 0xff should be set if this field is invalid |

SNR Reporting Details for PUSCH as per FAPI

Whenever RSSI data valid signal pulse arrives (311) from the RSSI measurement unit, the SNR unit may capture User Identity (UID) flag value and concatenated RSSI value. Similarly, whenever NV data valid pulse arrives (313) from the NV unit, the SNR unit may capture concatenated NV values. The RSSI values and the NV values may be processed UE wise in a sequential manner. After processing the SNR dB, output may be obtained along with a valid flag. Each sub-component of the SNR measurement unit implemented in the FPGA (for approach 1) is explained in detail below:

The RSSI data and the UID flag may be stored in a register when the RSSI valid pulse arrives (311), and an internal RSSI flag may be set. The NV data may be stored, when the NV valid pulse arrives (313), and an internal NV flag may be set. When the RSSI flag and the NV flag both are set high, an internal enable signal may be set. The UE wise corresponding RSSI and NV values may be passed sequentially based on an enabled signal for further processing. Based on the counter value, the RSSI values and the NV values may be passed to a subtractor IP (315). Further, the RSSI-NV operation may be performed to obtain signal power in case of approach 1. Further, the signal power and the NV may be passed to a fixed to floating-point converter (317). The signal power/NV division operation may be performed using a divider (319) in a floating-point single-precision format. A natural logarithm (log) (321) may be performed for an obtained result from the signal power/NV division operation. The resultant value may be converted from a floating-point precision to a fixed-point precision using a floating to fixed-point converter (323). A multiplier (325) may be used to multiply the converted value with 4.342 to get the SNR value in dB. Above steps may be repeated to obtain 8 RSSI and NV values (or depending on the bit map in the received UID_Flag, where Most Significant Bit (MSB) bit is UE8 and Least Significant Bit is UE1). This is an example, and not limited to processing 8 UEs (104).

In approach 2 and approach 3, SNR (dB)=RSSIₘₑₐₙ/NVₘₑₐₙ. So, the subtraction shown above in the blocks of FIG. 3B may not be used. Alternatively, logarithm may be taken first and values may be subtracted in such a way that the division block need not be used. For example, 10*(log 10(RSSIₘₑₐₙ)−log 10(NVₘₑₐₙ)). Further, an offset value may be added to the calculated SNR value in PS or in PL to tune the reporting as per the noise figure of the radio and quantization noise at ADC. For example, SNR_reported=SNR_fapi+Offset. Therefore, good performance of SNR reporting may be achieved.

Although FIG. 3B shows the exemplary block diagram (300B) of the SNR measurement unit, in other embodiments, the SNR measurement unit may include fewer components, different components, differently arranged components, or additional functional components than depicted in FIG. 3B. Additionally, or alternatively, one or more components of the SNR measurement unit may perform functions described as being performed by one or more other components of the SNR measurement.

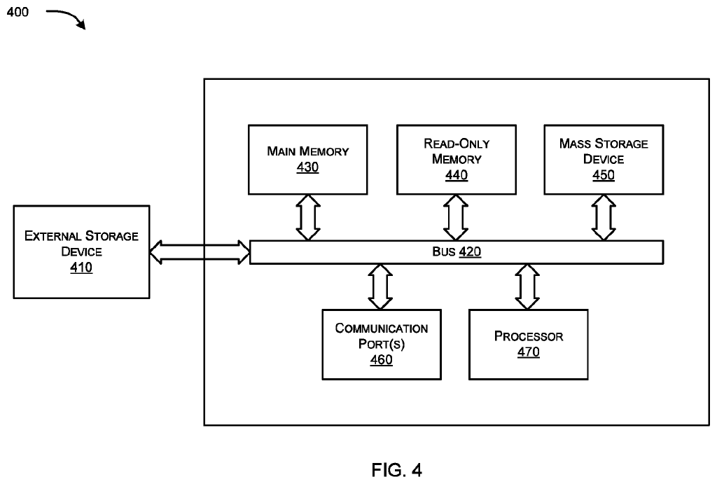

FIG. 4 illustrates an exemplary computer system (400) in which or with which embodiments of the present disclosure may be implemented.

As shown in FIG. 4, the computer system (400) may include an external storage device (410), a bus (420), a main memory (430), a read only memory (440), a mass storage device (450), a communication port (460), and a processor (470).

A person skilled in the art will appreciate that the computer system (400) may include more than one processor and communication ports. The processor (470) may include various modules associated with embodiments of the present disclosure.

In an embodiment, the communication port (460) may be any of an RS-232 port for use with a modem-based dialup connection, a 10/100 Ethernet port, a Gigabit or 10 Gigabit port using copper or fiber, a serial port, a parallel port, or other existing or future ports. The communication port (460) may be chosen depending on a network, such a Local Area Network (LAN), Wide Area Network (WAN), or any network to which the computer system (400) connects.

In an embodiment, the memory (430) may be a Random Access Memory (RAM), or any other dynamic storage device commonly known in the art. The read-only memory (440) may be any static storage device(s) e.g., but not limited to, a Programmable Read Only Memory (PROM) chips for storing static information e.g., start-up or Basic Input/Output system (BIOS) instructions for the processor (470).

In an embodiment, the mass storage (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (420) communicatively couples the processor(s) (470) with the other memory, storage, and communication blocks. The bus (420) may be, e.g., a Peripheral Component Interconnect (PCI)/PCI Extended (PCI-X) bus, Small Computer System Interface (SCSI), Universal Serial Bus (USB or the like, for connecting expansion cards, drives, and other subsystems as well as other buses, such a front side bus (FSB), which connects the processor (470) to computer system (400).

Optionally, operator and administrative interfaces, e.g., a display, keyboard, joystick, and a cursor control device, may also be coupled to the bus (420) to support direct operator interaction with the computer system (400). Other operator and administrative interfaces may be provided through network connections connected through the communication port (460). Components described above are meant only to exemplify various possibilities. In no way should the aforementioned exemplary computer system (400) limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

### ADVANTAGES OF THE PRESENT DISCLOSURE

The present disclosure provides systems and methods for measuring a Signal to Noise (SNR) ratio for an uplink receiver chain.

The present disclosure achieves accurate SNR reporting to higher layers of a core network for better receiver performance.

The present disclosure enables optimal implementation of SNR unit using fewer Field Programmable Gate Array (FPGA) resources.

The present disclosure uses different methods implemented in the FPGA to achieve good performance of reporting in negative ranges of SNR.

The present disclosure determines Received Signal Strength Indicator (RSSI) values and Noise Variance (NV) values in FPGA for determining the SNR efficiently.

The present disclosure allows user-by-user measurement of SNR values, thereby saving FPGA resources by serializing the measurements.

The present disclosure provides systems and methods for adding an offset to the calculated SNR values, which may tune the reporting as per a noise figure of radio and quantization noise at an Analog to Digital Converter (ADC).

We claim:

1. A system (110) for measuring Signal to Noise Ratio (SNR) for an uplink receiver chain, the system (110) comprising:
one or more processors (202); and
a memory (204) operatively coupled to the one or more processors (202), wherein the memory (204) comprises processor-executable instructions, which on execution, cause the one or more processors (202) to:
receive at least one Demodulation Reference Signal (DMRS) symbol from at least one signal of a plurality of signals transmitted by a plurality of User Equipments (UEs) (104) in the uplink receiver chain;
determine Received Signal Strength Indicator (RSSI) of the at least one signal of each UE of the plurality of UEs (104) based on the at least one DMRS symbol;
determine an average Noise Variance (NV) of the at least one signal of each UE (104) in response to the determination of the RSSI of the at least one signal of each UE (104); and
measure the SNR for the at least one signal of each UE (104) in the uplink receiver chain based on the RSSI of the at least one signal and the average NV of the at least one signal.

2. The system (110) as claimed in claim 1, wherein the RSSI of the at least one signal is an average signal strength of the at least one signal.

3. The system (110) as claimed in claim 1, wherein the one or more processors (202) are to determine the average NV of the at least one signal of each UE (104) by being configured to:
estimate one or more smoothened channels of the at least one signal and one or more frequency interpolated channels of the at least one signal based on the at least one DMRS symbol;
determine noise mean power per antenna per Resource Element (RE) from the estimated one or more smoothened channels and the estimated one or more frequency interpolated channels; and
determine the average NV of the at least one signal of each UE (104) based on the noise mean power per antenna per RE.

4. The system (110) as claimed in claim 3, wherein the one or more processors (202) are to measure the SNR for the at least one signal of each UE (104) by being configured to:
determine power of the at least one signal of each UE based on the RSSI of the at least one signal; and
measure the SNR for the at least one signal of each UE (104) in the uplink receiver chain based on the power of the at least one signal of each UE (104) and the noise mean power per antenna per RE.

5. The system (110) as claimed in claim 4, wherein the one or more processors (202) are to determine the power of the at least one signal of each UE (104) by being configured to:
estimate a User Identity (UID) flag value and a concatenated RSSI value from the RSSI of the at least one signal to set an internal RSSI flag;
estimate concatenated NV value from the average NV of the at least one signal to set an internal NV flag;
set an internal enable signal based on the internal RSSI flag and the internal NV flag;
process the UID flag value, the concatenated RSSI value, and the concatenated NV value based on the internal enable signal; and
determine the power of the at least one signal of each UE based on the processed values.

6. The system (110) as claimed in claim 1, wherein the memory (204) comprises processor-executable instructions, which on execution, cause the one or more processors (202) to send, via a Functional Application Platform Interface (FAPI), a SNR measurement report of each UE (104) in the uplink receiver chain to one or more higher layers of a base station.

7. The system (110) as claimed in claim 1, wherein the memory (204) comprises processor-executable instructions, which on execution, cause the one or more processors (202) to add an offset to the measured SNR, which tunes a SNR measurement report of each UE (104) as per a noise figure of radio and quantization noise at an Analog to Digital Converter (ADC).

8. A method for measuring Signal to Noise Ratio (SNR) for an uplink receiver chain, the method comprising:
receiving, by a processor (202) associated with a system (110), at least one Demodulation Reference Signal (DMRS) symbol from at least one signal of a plurality of signals transmitted by a plurality of User Equipments (UEs) (104) in the uplink receiver chain;
determining, by the processor (202), Received Signal Strength Indicator (RSSI) of the at least one signal of each UE of the plurality of UEs (104) based on the at least one DMRS symbol;
determining, by the processor (202), an average Noise Variance (NV) of the at least one signal of each UE (104) in response to the determination of the RSSI of the at least one signal of each UE (104); and
measuring, by the processor (202), the SNR for the at least one signal of each UE (104) in the uplink receiver chain based on the RSSI of the at least one signal and the average NV of the at least one signal.

9. The method as claimed in claim 8, wherein the RSSI of the at least one signal is an average signal strength of the at least one signal.

10. The method as claimed in claim 8, wherein determining, by the processor (202), the average NV of the at least one signal of each UE (104) comprises:
estimating, by the processor (202), one or more smoothened channels of the at least one signal and one or more frequency interpolated channels of the at least one signal based on the at least one DMRS symbol;
determining, by the processor (202), noise mean power per antenna per Resource Element (RE) from the estimated one or more smoothened channels and the estimated one or more frequency interpolated channels; and
determining, by the processor (202), the average NV of the at least one signal of each UE (104) based on the noise mean power per antenna per RE.

11. The method as claimed in claim 10, wherein measuring, by the processor (202), the SNR for the at least one signal of each UE (104) comprises:
determining, by the processor (202), power of the at least one signal of each UE (104) based on the RSSI of the at least one signal; and
measuring, by the processor (202), the SNR for the at least one signal of each UE (104) in the uplink receiver chain based on the power of the at least one signal of each UE (104) and the noise mean power per antenna per RE.

12. The method as claimed in claim 11, wherein determining, by the processor (202), the power of the at least one signal of each UE (104) comprises:
estimating, by the processor (202), a User Identity (UID) flag value and a concatenated RSSI value from the RSSI of the at least one signal to set an internal RSSI flag;
estimating, by the processor (202), a concatenated NV value from the average NV of the at least one signal to set an internal NV flag;
setting, by the processor (202), an internal enable signal based on the internal RSSI flag and the internal NV flag;
processing, by the processor (202), the UID flag value, the concatenated RSSI value, and the concatenated NV value based on the internal enable signal; and
determining, by the processor (202), the power of the at least one signal of each UE (104) based on the processed values.

13. The method as claimed in claim 8, wherein the method comprises:
sending, via a Functional Application Platform Interface (FAPI), by the processor (202), a SNR measurement report of each UE (104) in the uplink receiver chain to one or more higher layers of a base station.

14. The method as claimed in claim 8, comprising adding, by the processor (202), an offset to the measured SNR, which tunes a SNR measurement report of each UE (104) as per a noise figure of radio and quantization noise at an Analog to Digital Converter (ADC).

15. A user equipment (104), comprising:
one or more processors; and
a memory operatively coupled to the one or more processors, wherein the memory comprises processor-executable instructions, which on execution, cause the one or more processors to:
transmit, via a communication network (106), a plurality of signals to a system (110),
wherein the one or more processors are communicatively coupled with the system (110), and wherein the system (100) is configured to:
receive at least one Demodulation Reference Signal (DMRS) symbol from at least one signal of the plurality of signals;
determine Received Signal Strength Indicator (RSSI) of the at least one signal of UE (104) based on the at least one DMRS symbol;
determine an average Noise Variance (NV) of the at least one signal of the UE (104) in response to the determination of the RSSI of the at least one signal of the UE (104); and
measure a Signal to Noise Ratio (SNR) for the at least one signal of the UE (104) in an uplink receiver chain based on the RSSI of the at least one signal and the average NV of the at least one signal.

16. A non-transitory computer-readable medium comprising processor-executable instructions that cause a processor to:
receive at least one Demodulation Reference Signal (DMRS) symbol from at least one signal of a plurality of signals transmitted by a plurality of User Equipments (UEs) (104) in an uplink receiver chain;
determine Received Signal Strength Indicator (RSSI) of the at least one signal of each UE (104) of the plurality of UEs (104) based on the at least one DMRS symbol;
determine an average Noise Variance (NV) of the at least one signal of each UE (104) in response to the determination of the RSSI of the at least one signal of each UE (104); and
measure a Signal to Noise Ratio (SNR) for the at least one signal of each UE (104) in the uplink receiver chain based on the RSSI of the at least one signal and the average NV of the at least one signal.
